(19) United States
(12) Patent Application Publication
(10) Pub. No.: US 2014/0367332 A1
(43) Pub. Date: Dec. 18, 2014

(54) SEPTIC SYSTEM AND METHOD OF TREATING SEWAGE AND GREASE

(71) Applicant: Hadi Hillo, Santa Clarita, CA (US)

(72) Inventor: Hadi Hillo, Santa Clarita, CA (US)

(21) Appl. No.: 13/916,355

(22) Filed: Jun. 12, 2013

(51) Int. Cl. C02F 3/28

(52) U.S. Cl. CPC C02F 3/28
USPC 210/613; 210/170.08; 210/601

(57) ABSTRACT

A septic system is provided which receives both sewage and fat, oil, and grease (FOG) at an inlet. The inlet provides fluids to a first chamber. A treatment unit is adjacent the inlet. The treatment unit includes a unit for breaking down solids and mixing them with surrounding liquid. Hydro-jetting water and oxygen into the mixture at high or low pressures achieves oxygenation. Jets injecting an enzyme solution provide for maximum contact with the waste. Injection pressure may be selected to achieve rapid oxygenation at a high level. Optionally, the water may be heated. In another form, hot or cold water is injected at selected times. Temperature may be controlled to keep enzymes working properly. Enzymes may be directly injected and carried by liquid that is hydro-jetted into the fluids being treated.

### CROSS REFERENCE TO RELATED APPLICATIONS

This patent application claims priority of Provisional Patent Application 61/658,803 filed Jun. 12, 2012.

### BACKGROUND OF THE INVENTION

1. Field of the Invention

The present subject matter relates to a septic system for treating both sewage and FOG (fat, oil, and grease) and a method.

2. Related Art

There are many forms of septic treatment systems. Normally, septic systems treat only sewage. Waste fat, oil, and grease (FOG) is diverted to a grease trap. Grease is treated separately before being transported through an outlet. Mechanical treatment may be used in some septic systems to augment chemical treatment of effluents so that they may be safely sent to a septic tile field.

Septic tanks receive waste fluid such as sewage. The sewage is treated so that liquid exiting from the septic tank may be safely discharged into an underground tile field. Due to build up of solids, septic tanks must be periodically pumped out, e.g., every two or three years. Another significant effect of solids buildup is the coating of tiles in the field. After sufficient buildup, it may be necessary to dig up the tile field and provide replacement tiles. Septic tanks have not traditionally been designed to treat both sewage and grease. The standard method of treating grease is by directing grease to a grease trap. Grease is removed from the trap. The prior art apparatus does not provide for the ability to simply allow grease to enter the waste stream.

U.S. Pat. No. 3,638,869 discloses a sewage comminutor installation including a generally cylindrical comminutor rotatable about a vertical axis. The housing is generally scroll-shaped to define a flow passage with progressively diminishing width. Incoming pieces of material carried with sewage are broken up. This system does not contemplate comminution of the sewage itself. There is no suggestion of combining different types of waste fluids.

U.S. Pat. No. 5,540,386 discloses a wastewater treatment system and method for substantially reducing total suspended solids, biological organic discharge, and FOG contaminants. Drag lines are included in tanks for removing floating and settled contaminants. This system is a mechanical system and not a septic system.

U.S. Pat. No. 5,885,950 discloses a composition for treating both sewage and grease that may flow into a septic tank. However, no particular apparatus is disclosed.

### SUMMARY

Briefly stated, in accordance with the present subject matter, a septic system is provided which receives both sewage and FOG at an inlet. An inlet provides fluids to a first chamber. A treatment unit is adjacent the inlet. The treatment unit includes a unit for breaking down solids and mixing them with surrounding liquid. Hydro-jetting water and oxygen into the mixture at high or low pressures achieves oxygenation. Jets injecting an enzyme solution provide for maximum contact with the waste. Injection pressure may be selected to achieve rapid oxygenation at a high level. Optionally, the water may be heated. In another form, hot or cold water is injected at selected times. Temperature may be controlled to keep enzymes working properly. Enzymes may be directly injected and carried by liquid that is hydro-jetted into the fluids being treated. Efficiency of waste treatment is provided reducing the amount of sludge provided and reducing the frequency of necessary pumping of the septic tank.

### BRIEF DESCRIPTION OF THE DRAWINGS

The present subject matter may be further understood by reference to the following description taken in connection with the following drawings:

FIG. 1 is a basic diagram of a house or other structure utilizing a septic system;

FIG. 2 is a perspective view, partially broken away, of a prior art septic system;

FIG. 3 is a cross-sectional elevation of a septic system constructed in accordance with the present subject matter;

FIG. 4 is a cross-sectional view showing in greater detail a treatment unit adjacent a septic tank inlet;

FIG. 5 is a cross-sectional view showing an alternative of the embodiment of FIG. 4;

FIG. 6 is a cross-sectional view illustrating injection of water, oxygen, and enzymes;

FIG. 7 is a cross-sectional elevation illustrating further apparatus which may be included in the present system;

FIG. 8 is a cross sectional view of an embodiment in which methane gas is captured from the septic tank;

FIG. 9 is an illustration of a further embodiment comprising an alternative form of treatment unit;

FIG. 10 is an elevation of the septic tank with a sidewall removed in which a single motive source is provided for pumps; and

FIG. 11 is a plan view of a jetter nozzle.

### DETAILED DESCRIPTION

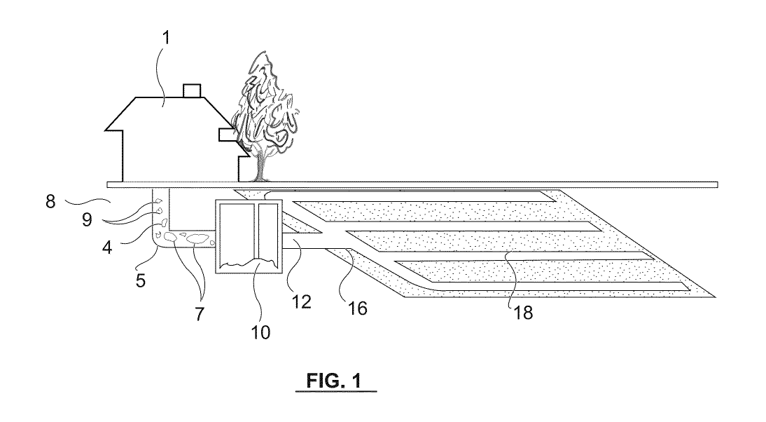

FIG. 1 is a basic diagram of a structure utilizing a septic system. The structure is referred to in the present description as a house 1, but could be virtually any structure. A soil pipe 5 is installed in the ground 8. The soil pipe 5 conducts sewage 4 to a septic tank 10. Septic tank 10 treats sewage 4 as described below. The sewage 4 includes waste masses 7 and grease globules 9. The waste masses 7, primarily comprising feces, paper, and other organic matter, are treated so that they will be emulsified or otherwise turned into liquid so that they may be transported to the leach fields 18. Effluents 12 from the septic tank 10 flow through an effluent pipe 16 to leach fields 18. Additionally, a pumping unit (not shown) may be provided between the septic tank 10 and leach fields 18 if the leach fields are at a higher elevation.

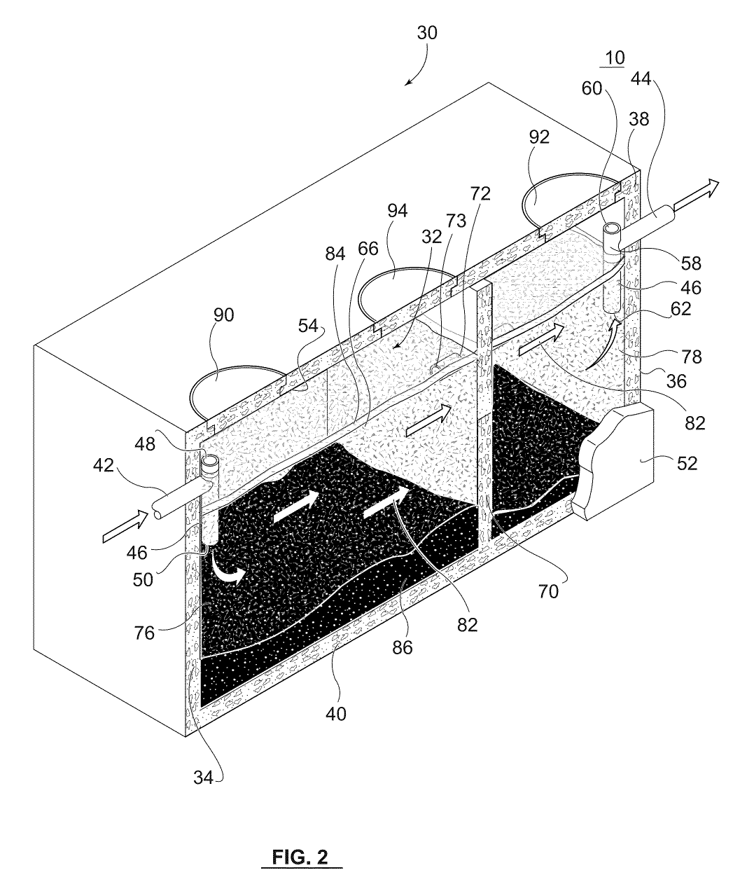

FIG. 2 is a perspective view, partially broken away, of a prior art septic tank 10. The septic tank 10 comprises a housing 30 containing a chamber 32. The chamber 32 is designed to hold liquid. Common shapes for a chamber 30 include a box or cylinder. Other shapes could be used. The chamber 32 has first and second opposite end walls 34 and 36. The chamber 32 also has upper and lower walls 38 and 40. An inlet pipe 42 receives sewage from the soil pipe 5. The inlet pipe 42 projects through the first wall 34 into the chamber 32. An outlet pipe 44 carries the effluent 12 (FIG. 1) from the chamber 32 to the leach fields 18. This construction maintains a liquid level of an effluent surface 66 below the inlet pipe 40 and output pipe 44. The chamber 32 also comprises opposite sidewalls 52 and 54.

As further described below, effluent is treated with mixing fluids to break down solids. Mixing fluids include air and water and may include enzyme solutions and bacteria.

Waste enters the chamber 32 through a tee 46 communicating with the end of the inlet pipe 42. The tee 46 has an upper, access port 48 and a lower, inlet port 50. Waste exits from the compartment 78 through the outlet pipe 44. A tee 58 has an upper, access port 60 and a lower, outlet port 62. A vertical wall 70 has an opening 72 and defines compartments 76 and 78. The compartments 76 and 78 contain the inlet pipe 42 and the outlet pipe 44 respectively. The upper wall 40 contains first and second inspection lids 90 and 92 and a clean-out lid 94. The first inspection lid 90 is preferably in registration with the access port 48 of the tee 46. The second inspection lid 92 is preferably in registration with the access port 60 of the tee 58. The clean-out lid 94 may be located centrally between the first and second vertical walls 34 and 36.

Sewage enters the compartment 76 through the inlet port 50. The liquid in the compartment 76 is referred to as black water. The liquid in the compartment 78 is called gray water. Liquid flows along a path 82 from the inlet port 50 through the opening 72 in the wall 70 into the compartment 78 and out the outlet port 62 and outlet pipe 44 to the effluent pipe 16 (FIG. 1). The opening 72 may contain a filter 73 in order to prevent solids from flowing through the wall 70. Alternatively, the wall 70 may be solid and have a height such that liquid leaches over the wall 70. In many applications, it will not be necessary to service the filter 73 any more often then it will be necessary to pump the septic tank 10.

Sewage entering the compartment 76 contains liquids and the waste masses 7. Many forms of treatment exist. Both surfactants and bacteria may be used. Remaining solids either float to a scum layer 84 at the effluent surface 66 or sink to the bottom of the chamber 32 to a sludge layer 86. If these solids are not removed, they can eventually slow down or even stop the flow to the drain field. Solids could also plug the inlet pipe 40 or the outlet pipe 44. This can lead to disastrous, unpleasant, and expensive consequences. Therefore, it is conventional to remove the solids by pumping out the septic system every two to three years.

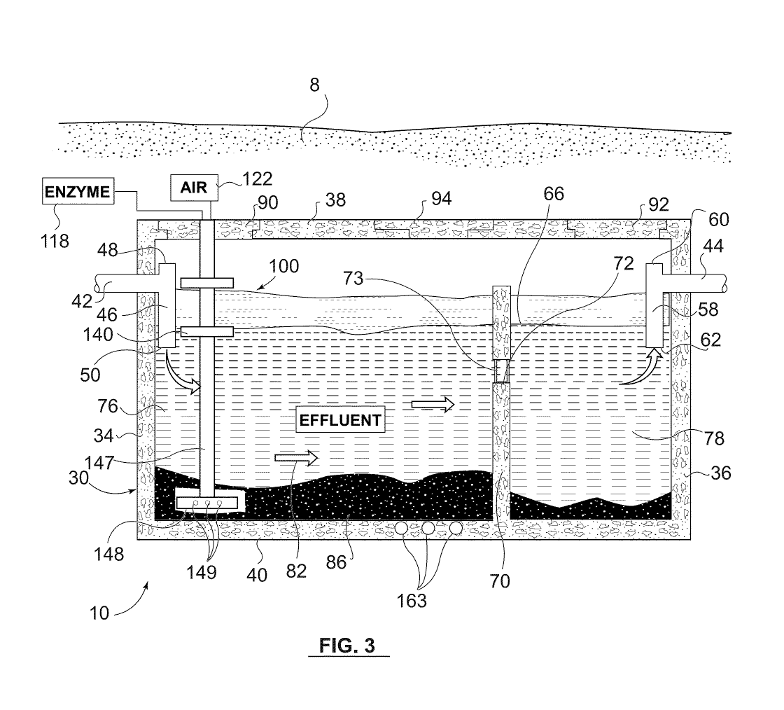

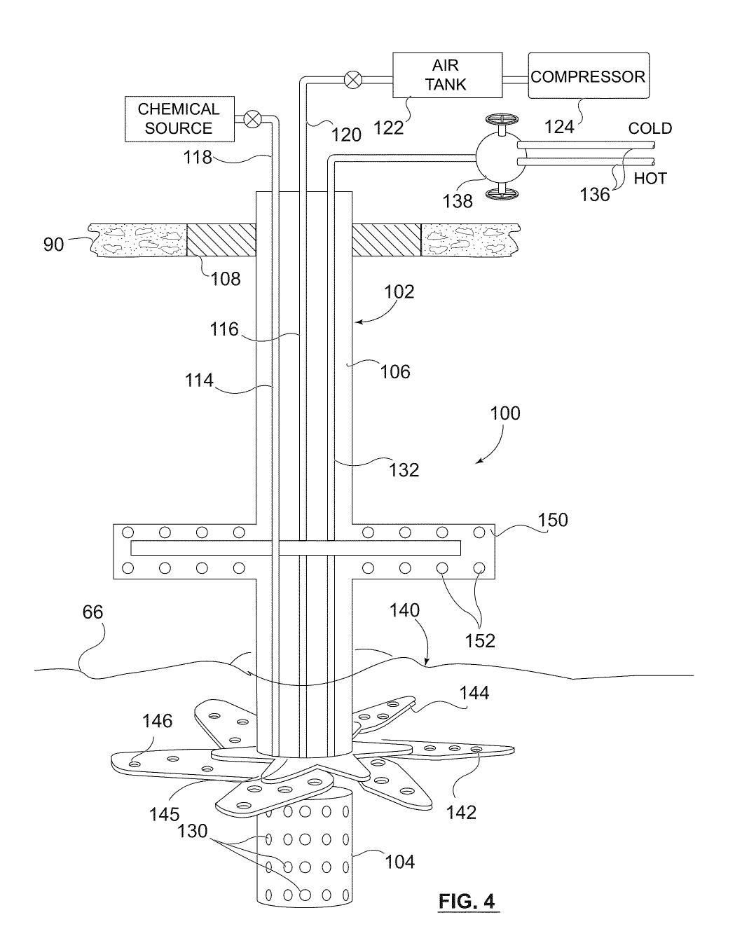

FIG. 3 is a partial cross-sectional elevation of a septic tank 10 constructed in accordance with the present subject matter. In FIG. 3, the same reference numerals are used to denote components corresponding to those of FIG. 2. In the embodiment of FIG. 3, a treatment unit 100 is positioned adjacent the input port 50. The treatment unit 100, further described with respect to FIG. 4, is constructed to improve efficiency and effectiveness of both physical and chemical aspects of the waste treatment process. The treatment unit 100 is coupled to a chemical treatment source 118 and a source of fluid pressure 120, preferably air, for improved mixing. The treatment source 118 and a source of pressure 120 are each further described with respect to FIG. 4. Consequently, the septic tank 10 may require pumping much less frequently than every two or three years.

FIG. 4 is a cross-sectional view showing the treatment unit 100 in greater detail. The treatment unit 100 comprises a main support 102. The main support 102 may comprise a vertically disposed shaft 106. A hydro jet 104 is provided projecting downwardly and coaxially from the shaft 106. The main support 102 is supported at an upper end in a collar 108. The collar 108 may be disposed in the inspection lid 90. The main support 102 may enclose conduits, e.g., first and second conduits 114 and 116. The first and second conduits 114 and 116 may be connected to first and second supply lines 118 and 120 respectively. An air reservoir 122 provides air flow through the first supply line 118 to the first conduit 114. The air reservoir 122 is pressurized by a compressor 124. A fluid path is connected from the first conduit 114 to the hydro jet 104. The hydro jet 104 contains output nozzles 130. A third supply line 132 provides water to the treatment unit 100. A hot and cold water supply 136 having a mixing valve 138 may supply water that is hot, cold, or mixed to the supply line. The supply line 132 in one form may be connected to supply power to rotate the blades 142 and 144.

The main support 102 also supports a breaking unit 140 supported preferably just below the liquid surface 66. The breaking unit breaks up solids entering the compartment 76. Many different forms of breaking unit 140 may be provided, depending on the degree of breaking desired and the cost of components. In the present embodiment, the breaking unit 140 comprises first and second blades 142 and 144. These can break up solid masses 7. The first and second blades 142 and 144 in the present illustration are counter-rotating. This is preferable in terms of effectiveness of comminution. Also counter rotating blades cancel force moments applied to the main support 104. A gear unit 145, for example, a pinion gear unit, may be connected between the first and second blades 142 and 144. The first blade 142 is driven directly. The second blade 142 is driven in an opposite direction through the gear unit 145. However, this is not essential. The compressor 124 may provide power to rotate the first and second blades 142 and 144. The blades 142 and 144 may also be provided with nozzles 146 through which air, water, and/or chemical compounds may be dispensed. A jet ring 150 having outlet nozzles 152 is coupled to the second conduit 116 to provide enzyme solution. The jet ring 150 is located axially intermediate the breaking unit 140 and the collar 108.

The breaking unit 140 further comprises a shaft 147 (FIG. 3) also mounted for rotation. A mixing blade 148 rotates with the shaft 147. The mixing desk 148 preferably comprises outlet nozzles 149. The mixing blade 148 is positioned so that it will be in the sludge layer 86. The conduits 114, 116, and 132 may be each coupled to the mixing blade 148. All of the outlet nozzles may be connected to one conduit. Alternatively, each nozzle 149 may be connected to one selected conduit. The mixing blade 148 may also be used to dispense enzymes, air, and/or water. Other agitation means may also be provided. For example, jets 163 (FIG. 3) may be built into one or more walls of the housing 34 and coupled to sources of materials to be dispensed. Any of the jets described above could also be connected to a booster pump.

The mixing blade 148 comprises means for agitating the sludge layer 86. Agitation helps keep particles of the sludge layer 86 in suspension. Therefore, the particles will have greater surface contact with treating agents. The agitation means need not be a blade. In one nominal embodiment, the mixing blade 148 should rotate slowly. In this context, slowly may be under 100 RPM.

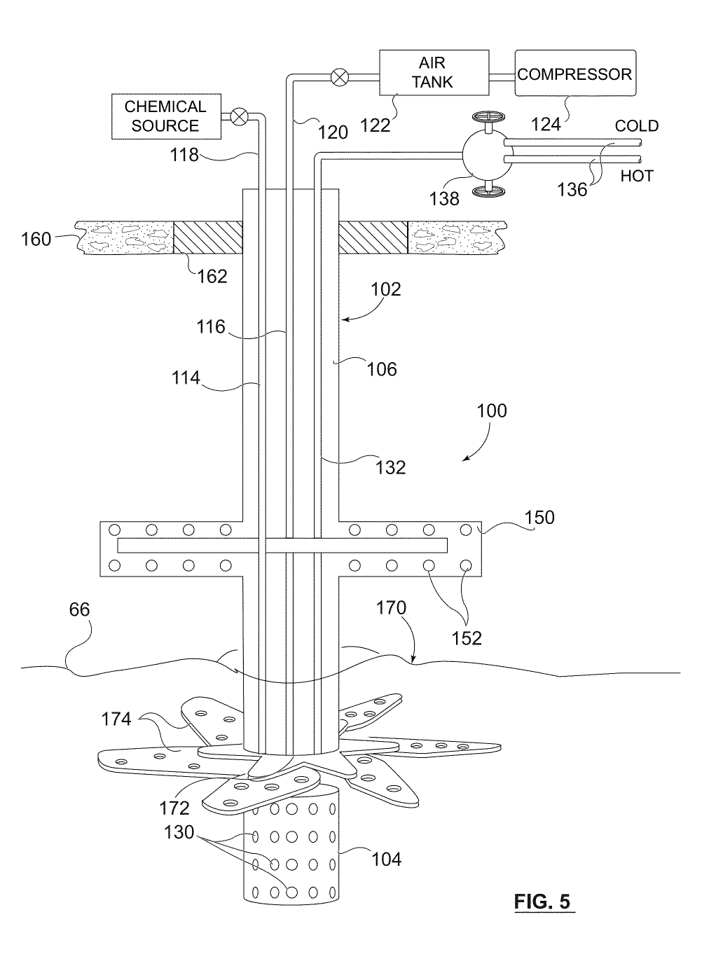

FIG. 5 is an illustration of an alternative embodiment to that of FIG. 4. The same reference numerals are used to denote elements corresponding to those of FIG. 4. The treatment unit 100 comprises a comminutor 170 comprising rotating discs 172 with grinding surfaces 174. The grinding surfaces 174 could comprise, for example, tungsten carbide. Tungsten carbide will pulverize most solids, and will be able to break up modules of soil or grease so as to form a suspension. This embodiment may be used in applications in which the sewage 4 will include such items as animal bones.

The embodiment of FIG. 5 has a treatment lid 160 received in the upper wall 38. The treatment lid 160 is provided so that the treatment means of the apparatus is separate from those components utilized during conventional septic tank operations. The main support 102 is received in a collar 162 in the treatment lid 160.

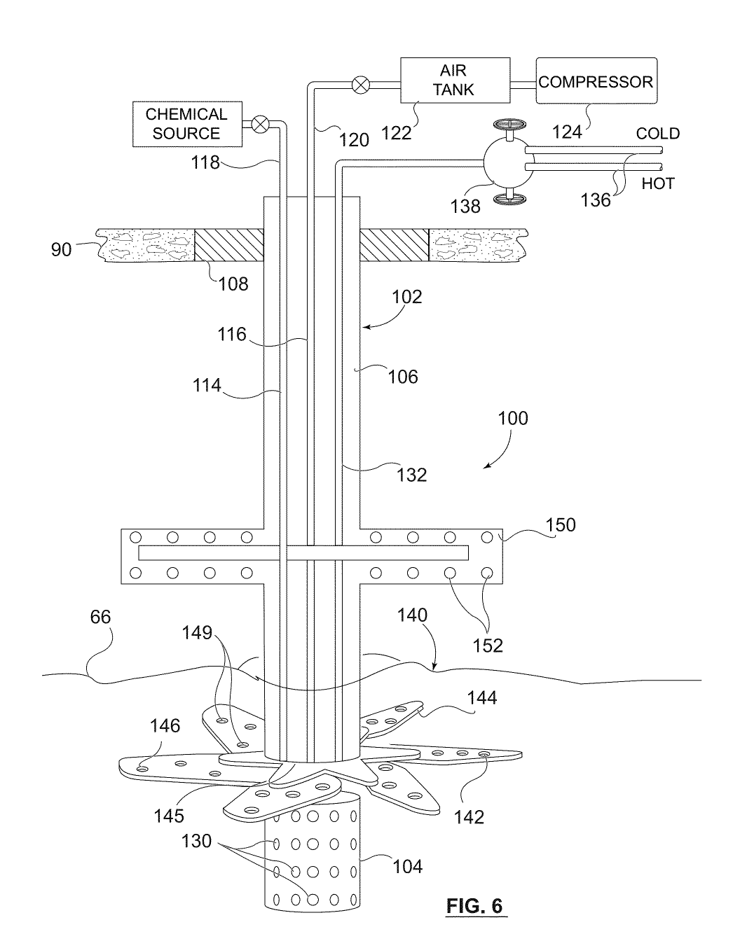

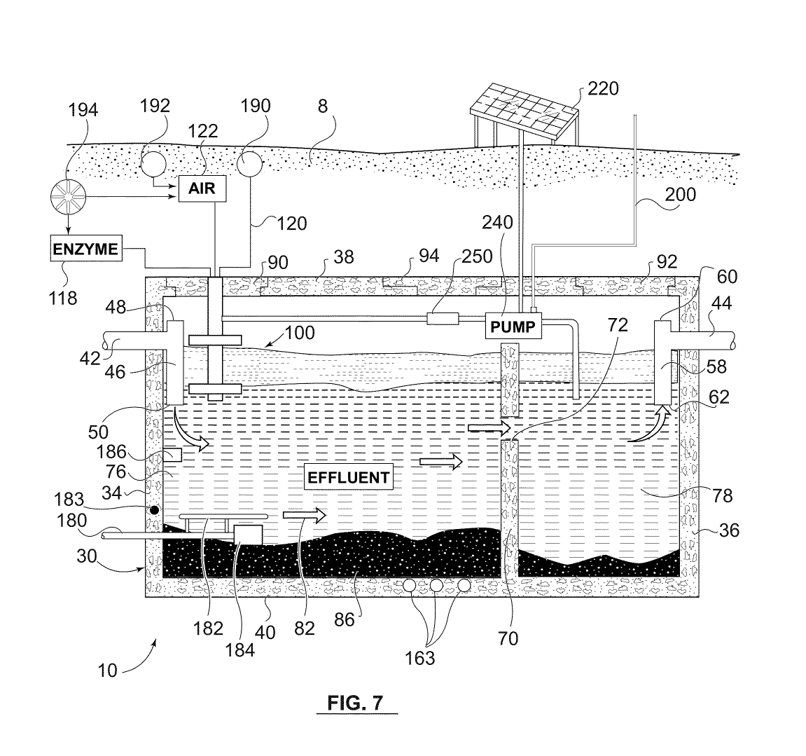

FIG. 6 is a partial cross-sectional view illustrating injection of water, oxygen, and enzymes. The counter-rotating blades 104 are in the waste stream entering the chamber 32. Waste masses 7 and grease globules 9 (FIG. 1) flow between the first and second blades 142 and 144. The waste masses 7 are intercepted by the first and second blades 142 and 144 and are broken down. Pressure in the flow also breaks the masses 7 down. The nozzles 130 of the hydro jet 104 provide bubbles of air to assist the waste masses 7 to mix with liquid in the chamber 32 and to move toward the blades 104. The supply of air from the supply 122 may be continuous, or it may be selectively enabled by a timer 192 (FIG. 7). The jets 152 spray enzyme solution into the chamber 32 over the treatment unit 100. The bubbles emerging from the hydro jets 104 create turbulence to maximize contact of the treatment enzymes with the waste masses 7. This leads to faster and more complete liquefaction of the waste masses 7.

FIG. 7 illustrates a septic tank 10 with still further additional features. An electrical conduit 180 is provided to power a heating element 182 at the bottom of the compartment 76. The heating element 182 may include a thermostat 184. Other heating elements could be included. For example, a heating element 183 could be included in any of the walls of the housing 34.

The heating element 182 may heat the liquid to a preselected level. In one form, the thermostat 184 is set to heat the liquid to a level 10° higher than the temperature at the inlet port 50 as sensed by a temperature sensor 186 providing an output to the thermostat 184. The amount of energy required to heat the liquid to a given level depends upon the difference between ambient temperature and the desired temperature. The heaters may be designed to provide, for example, a 15° F. increase in temperature. In one nominal embodiment, a preferred temperature level is 85° F.

In another form, the heating element 182 may comprise a plastic body which acts as a heat reservoir. This plastic has a chemical property which provides a temperature increase of 10-12° F. over ambient water temperature.

A pressure meter 190 may be provided on the air line 124, and a pressure controller 192 may be coupled to the air line 124. Control of the air pressure in the air line 124 will control velocity of air exiting the hydro jets 104 in the treatment unit 100. A timer 194 may energize the enzyme solution and the air pressure source automatically. Different operating cycles may be provided. In one form, the breaking unit 140 and agitation means, the mixing blade 148 (FIG. 6), are energized for 10 minutes each hour. Other schedules could be provided depending on the amount and type of sewage entering the septic tank 10.

Energy could be provided from an electric power line 200. Additionally or alternatively, a solar unit 220 may be used to provide power. Additionally, houses with well water systems may have a need for additional treatment while using less fresh water. A pump 240 may be used to provide gray water from the compartment 78 in order to supply water sources directed into the compartment 76. An in-line filter 250 may be used to take solids out of gray water.

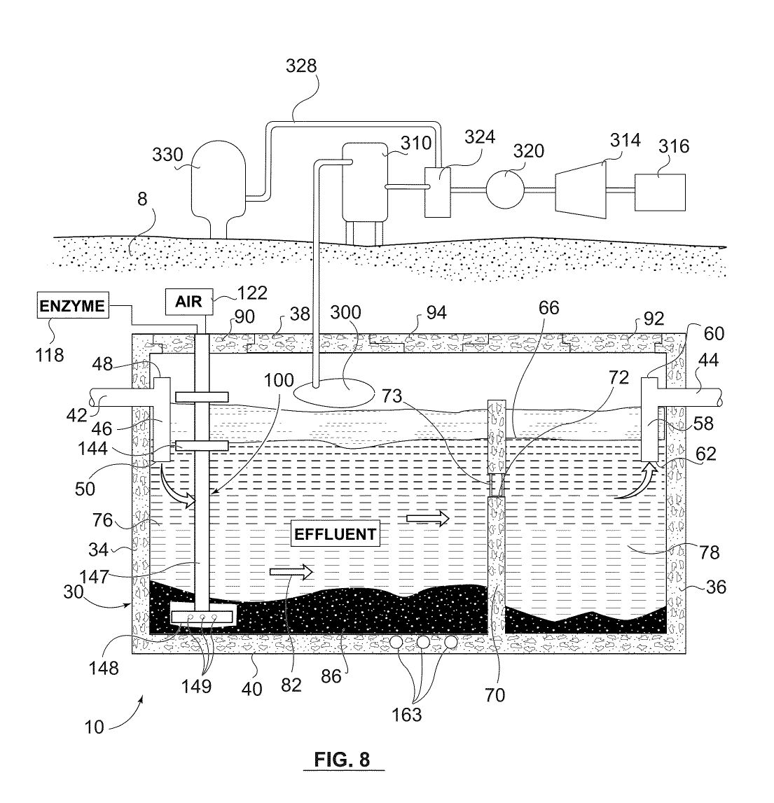

FIG. 8 discloses an embodiment in which methane gas is captured from the septic tank and used to produce electricity or other form of energy. Even human waste will supply sufficient methane gas to supplement power. The use of methane gas may be provided for residential, commercial, and industrial use. In the case of a farm application, the septic tank at least in part replaces cisterns into which cow manure is placed. According to the United States Department of Agriculture, different types of cows may produce 60-150 pounds of manure a day. In the septic tank, the cow manure produces sufficient methane gas to produce power in an industrial context.

The septic tank 10 further comprises a biogas collector 300 coupled by a gas conduit 304 through the upper surface of the septic tank 10 to a position above ground. The conduit 304 is coupled to a methane gas reservoir 310. The methane gas may be coupled to a gas turbine 314 that drives a gas turbo generator 316. A pressure regulator 320 regulates input pressure to a pressure usable by the gas turbine 314. A fluid switch 324 also provides for diversion of methane gas via a conduit 328. The fluid switch 324 may be positioned to direct methane gas to the turbine 314 or the methane tank 330, or to both. Additionally, the fluid switch 324 may be closed, with methane gas being stored in the methane gas reservoir 310.

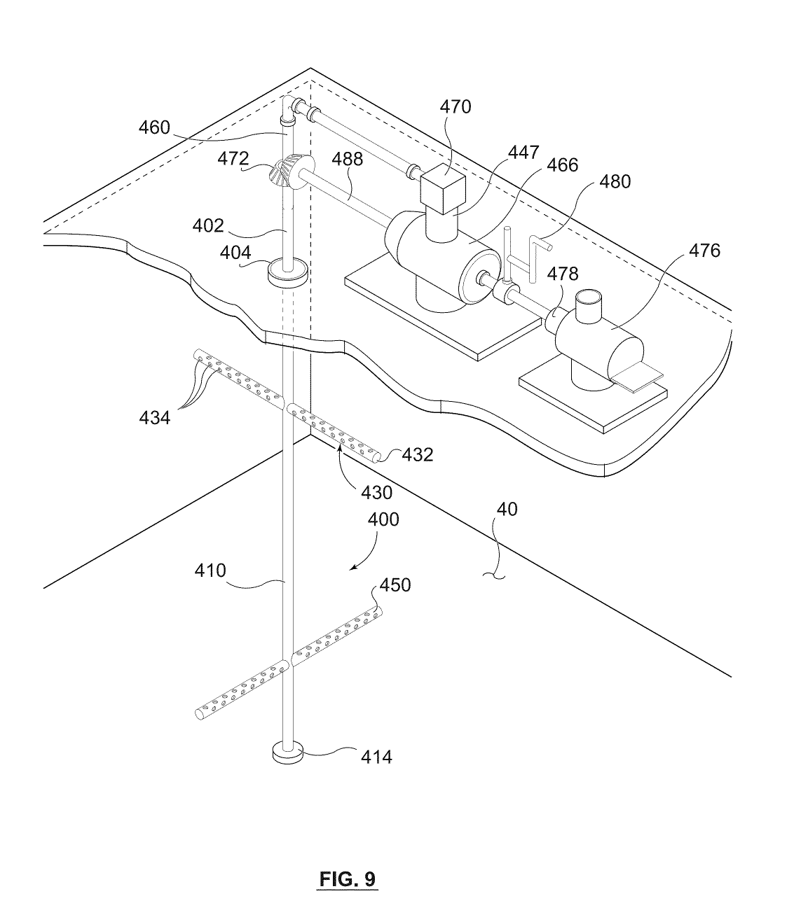

FIG. 9 is an illustration of a further embodiment comprising a treatment unit 400. The treatment unit 400 is an alternative to the treatment unit 100 described with respect to FIGS. 3, 4, and 5 above. FIG. 9 is an elevation of the septic tank 10 with the wall 52 removed. The treatment unit 400 comprises a central driveshaft 402, which extends through a journal bearing 404 in the top wall 38 of the septic tank 10. Extending from the central driveshaft 402 is a rotating sprayer support shaft 410. A lower end of the rotating sprayer support shaft 410 is received in a thrust bearing 414 at the bottom wall 40 of the septic tank 10. The rotating sprayer support shaft 410 includes conduits similar to those in the treatment unit 100. A first, upper sprayer 430 is mounted to the rotating sprayer support shaft 410. The upper sprayer 430 preferably comprises a cylinder 432 with sprayer holes 434. In one preferred embodiment, the upper sprayer 430 is perpendicular to the rotating sprayer support shaft 410 in both horizontal and vertical degrees of freedom. However, this is not necessary. Similarly, a lower rotating sprayer 450 is mounted in a vertical position calculated to be above the sludge layer 86 (FIG. 7).

The central driveshaft 402 is rotated by a gear assembly 460 driven by a motor 466. A central shaft drive rod 468 coupled to the motor 466 drives the gear assembly 460.

In accordance with a further feature of the present subject matter, the single motor 466 is used to drive the central driveshaft 402 as well as a water pump 470 and an air pump 476. The water pump 470 is driven by the motor 466 via a water pump gear assembly 472. The air pump 476 is driven by the motor 466 via an air pump gear assembly 478. Pulley assemblies may be used in place of gear assemblies, with the motor 466 being coupled to drive the water pump 470 and the air pump 476 by drive belts. In another form, the motor 466 may be replaced by a hand crank assembly 480. The hand crank assembly could also be used in conjunction with the motor 466 for such functions as moving rotating parts should a power failure occur.

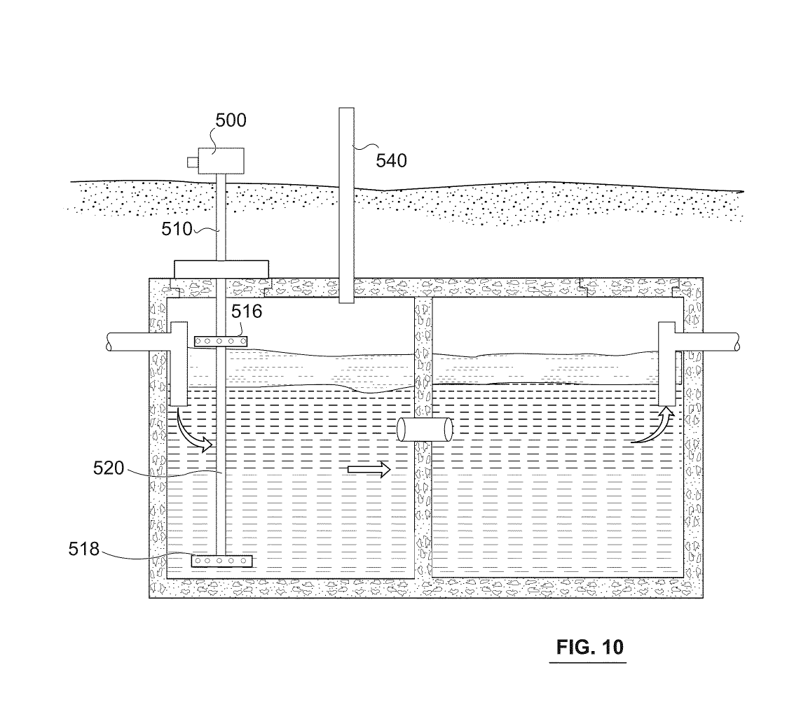

FIG. 10 is an elevation of the septic tank with the sidewall 52 removed. An embodiment is illustrated in which a jetter 500 is mounted above ground. A driveshaft 510 extends to the upper wall 36 of the septic tank 10. The same gear assemblies and water and air pumps may be provided as in the embodiment of FIG. 9. In this embodiment, the treatment unit 100 is utilized. The upper and lower sprayers 162 and 150 are replaced by upper and lower jetter nozzles 516 and 518 respectively. The upper and lower jetter nozzles 516 and 518 are rotatably mounted to a central shaft 520 (FIG. 10).

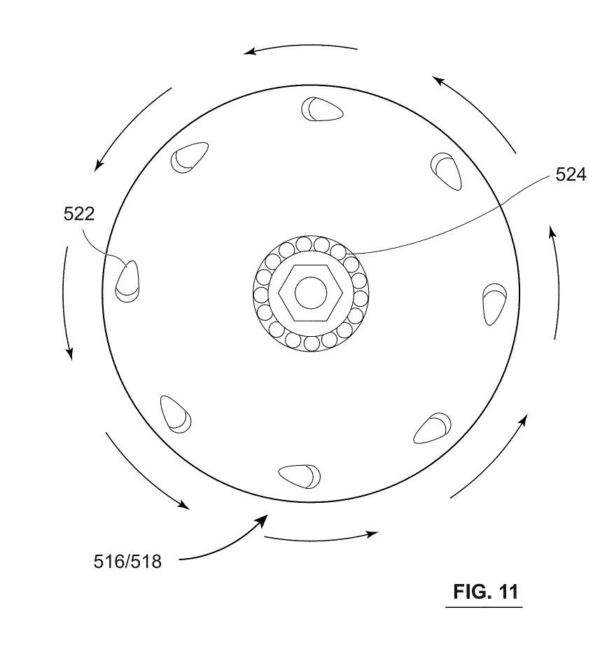

The upper and lower jetter nozzles 516 and 518 are mounted for rotation as further seen with respect to FIG. 11. FIG. 11 is a plan view of the jetter nozzle 516, and also illustrates the jetter nozzle 518 (FIG. 10). Each jetter nozzle 516 and 518 has a plurality of outlet holes 522. The holes 522 are tilted in the vertical and/or horizontal degree of freedom in order to create a force moment about the central shaft 520. A central bearing 524 permits rotation of the upper and lower jetter nozzles 516 and 518 with respect to the central shaft 520.

Additionally, in FIG. 10 a coupling conduit 540 is provided communicating with the chamber 32 (FIG. 2). The coupling conduit 540 may be used for selected purposes including adding enzyme solutions from above ground, monitoring sampled or evolved fluids, and transmission of gathered methane gas.

The method comprised in the present subject matter comprises directing sewage entering a septic tank toward a breaking unit. The breaking unit reduces the size of solids and globules of fluids immiscible in water. The sewage is treated with selected combinations of water, treatment chemicals, and air to maximize contact of sewage with treatment substances and increase the liquefaction of sewage and to reduce accumulation in scum and sludge layers. Treatment may be continuous or timed. Heating or other energy input may be provided.

Many other modifications may be made in accordance with the above teachings. Enzymes, air, and other treatment substances may be injected into the compartment 76 or even the compartment 78. Heaters may be located anywhere. An important consideration is maximizing the contact of treatable solids with the treatment substances. In this manner, build up of the sludge layer is minimized, and frequency of required septic tank pumping is minimized.

While the foregoing written description of the subject matter enables one of ordinary skill to make and use what is considered presently to be the best mode thereof, those of ordinary skill will understand and appreciate the existence of variations, combinations, and equivalents of the specific embodiment, method, and examples herein. The subject matter should therefore not be limited by the above described embodiment, method, and examples, but by all embodiments and methods within the scope and spirit of the subject matter as claimed.

What is claimed is:

1. A septic tank comprising: a housing including a chamber, the chamber being divided by an intermediate wall into a first compartment and a second compartment; an input port for receiving sewage and FOG effluent and communicating with the first compartment; an output port communicating with the second compartment; the intermediate wall having an opening, providing a path from the first compartment to the second compartment, the first compartment for processing black water and the second compartment receiving gray water; the inlet and outlet defining an effluent level; the septic tank in the normal course of operation forming a layer of scum above the effluent level and a layer of sludge at a bottom of the chamber; a treatment unit positioned adjacent the input port, the treatment unit comprising at least a first set of jets and a second set of jets, in a first set of jets located on said treatment unit above the effluent level and a second set of jets located on said treatment unit located below the effluent level, the jets communicating with sources of mixing fluids.

2. A septic tank according to claim 1 wherein in the treatment unit comprises a vertical support and in which the first set of jets and the second set of jets are coaxially mounted on the vertical support.

3. A septic tank according to claim 2 wherein the vertical support has source conduits housed within an inner diameter, the conduits each carrying a mixing fluid, and wherein conduits selectively are connected to the first set of jets and the second set of jets.

4. A septic tank according to claim 3 further comprising comminution means mounted for rotation on the vertical support.

5. A septic tank according to claim 4 wherein said comminution means comprises counter rotating first and second sets of rotating blades.

6. A septic tank according to claim 5 further comprising a mixing blade vertically positioned in a sludge layer zone and coupled to dispense mixing fluids.

7. The septic tank according to claim 6 wherein said mixing blade comprises a rotating blade.

8. A septic tank according to claim 7 comprising a conduit from said second compartment to said treatment unit and a pump delivering gray water to said treatment unit.

9. A septic tank according to claim 3 wherein each set of jets comprises a fetter nozzle.

10. A septic tank according to claim 3 further comprising a methane gas gatherer located above the effluent and communicating with a methane gas reservoir, and conduits coupling methane gas for further utilization.

11. The method for treating sewage and FOG effluent entering a septic comprising: directing effluent through an inlet, treating the effluent in an area adjacent the inlet including physically breaking solid pieces in the effluent, mixing treating fluid with the effluent from a position above or adjacent a scum level; treating the effluent with mixing fluid at a level below an effluent surface.

12. A method according to claim 11 wherein treating the effluent with mixing fluid comprises injecting air in the area above the effluent level and wherein the mixing fluid comprises an enzyme solution below the effluent surface.

13. A method according to claim 12 further comprising performing comminution below the effluent level in an area adjacent the inlet.

14. A method according to claim 13 further comprising modifying temperature of the effluent to facilitate efficacy of enzymes and anaerobic bacteria.

15. A method according to claim 14 further comprising agitating sludge in a lower portion of the septic tank and introducing mixing fluid into the sludge.

16. A method according to claim 15 further comprising collecting methane gas above the effluent level and moving methane gas outside of the septic tank.

17. A septic tank comprising: a housing including a chamber, the chamber being divided by an intermediate wall into a first compartment and a second compartment; an input port for receiving sewage and FOG effluent and communicating with the first compartment and comprising an inlet tee within the first compartment; an output port having an outlet tee in the second compartment and communicating with an outlet pipe; the intermediate wall having an opening providing a path from the first compartment to the second compartment, the first compartment for processing black water and the second compartment receiving gray water; the inlet tee and the outlet tee defining an effluent level; the septic tank in the normal course of operation forming a layer of scum above the effluent level and a layer of sludge at a bottom of the chamber; a treatment unit positioned adjacent the input port, the treatment unit comprising a hollow cylinder, an air conduit, an enzyme conduit, and a water conduit extending in an interior of the treatment unit, a first set of jets located above the effluent level, and having output apertures, the first set of jets being connected to the air conduit; a second set of jets located below the effluent level and coupled to the enzyme conduit.

18. A septic tank according to claim 17 further comprising an agitator adjacent a lower surface of the first compartment coupled to the treatment unit including means for imparting motion to sludge particles.
